(19) United States
(12) Patent Application Publication
(10) Pub. No.: US 2007/0188690 A1
(43) Pub. Date: Aug. 16, 2007

(54) LIQUID CRYSTAL DISPLAY DEVICE

(76) Inventors: Takahiro OCHIAI, Chiba (JP); Tohru Sasaki, Mobara (JP); Koichi Igeta, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/673,095

(22) Filed: Feb. 9, 2007

(30) Foreign Application Priority Data
Feb. 10, 2006 (JP) 2006-034082

(51) Int. Cl. G02F 1/1337

(52) U.S. Cl. 349/129

(57) ABSTRACT

The present invention provides a liquid crystal display device having a liquid crystal display panel in which a liquid crystal material is held between a first substrate and a second substrate. Liquid crystal molecules are aligned in a direction vertical to a surface of the substrate when a display is made in black; the second substrate has a first counter electrode; the first substrate has a pixel electrode, a protrusion for alignment control, and a second counter electrode having an electric potential different from an electric potential in the pixel electrode and different from an electric potential in the first counter electrode when a display is made in black; and the pixel electrode has a slit or an opening at a position where the protrusion for alignment control is formed, and the second counter electrode extends at a position overlapping the slit or the opening of the pixel electrode.

### CLAIM OF PRIORITY

The present application claims priority from Japanese Application JP 2006-034082 filed on Feb. 10, 2006, the content of which is hereby incorporated by reference into this application.

### BACKGROUND OF THE INVENTION

1. Field of the Invention

The present invention relates to a liquid crystal display device, and more specifically to a technique which is effective when applied to a liquid crystal display device using the VA (Vertical Alignment) system.

2. Description of the Related Art

There is a liquid crystal display device using the VA system. In the liquid crystal display device using the VA system, when a voltage is OFF, namely when a difference in potential between a pixel electrode and a counter electrode (also referred to as “common electrode”) is zero, liquid crystal molecules are aligned in the vertical direction with respect to a surface of a substrate. When the voltage is at the maximum level, the liquid crystal molecules are aligned in a direction parallel to the substrate surface. Furthermore, in the liquid crystal display device based on the VA system, a display is made in black when the voltage is OFF, and in white when the voltage is at the maximum level.

A liquid crystal display device based on the VA system is often combined with the multidomain technique for changing alignment of liquid crystal molecules from domain to domain in order to improve view angle characteristics. In this multidomain technique, a liquid crystal layer is divided to small domains, and alignment of the liquid crystal molecules when a voltage is applied is changed in each of the small domains. In other words, control is provided so that the liquid crystal molecules are orientated rightward in a domain and leftward in another domain. With the scheme described above, a light volume on the entire screen can be averaged and a color change according to a visual angle can substantially be suppressed.

A principle of the multidomain technique described above is based on a scheme in which, for instance, when a voltage is OFF, alignment of liquid crystal molecules along a border of each small domain is not vertical with respect to a surface of the substrate and inclined in a direction with respect to the substrate surface. A specific technique for controlling alignment of the liquid crystal molecules is provided, for instance, by provided an opening in a pixel electrode (Refer to, for instance, Japanese Patent Laid-open No. 2005-3916), or by providing a protrusion for alignment control (Refer to, for instance, Japanese Patent Laid-Open No. 11-242225).

### SUMMARY OF THE INVENTION

In the method described in Patent document 1 above, an opening is provided in a pixel electrode and an electric field inclined in a diagonal direction is generated between the pixel electrode and a counter electrode to drive the liquid crystal, and an auxiliary capacitance electrode is formed in the opening.

In the method as described above, however, when a voltage is ON, namely when an electric field is generated to drive the liquid crystal, a point where alignment of the liquid crystal molecules is different from that in the border area (domain center) varies according to strength of the electric field. Because of this phenomenon, fluctuation of the domain center is recognized as non-uniformity in display, which is disadvantageously troublesome.

In the method described in Patent document 2, a partially inclined surface is provided on a surface of the substrate by providing a protrusion for alignment control. In this scheme, when liquid crystal molecules are aligned in the vertical direction with respect to a surface of the substrate, the liquid crystal molecules are aligned in the substantially vertical direction with respect to the inclined surface in a domain in which the protrusion for alignment control (inclined surface) is provided. With this configuration, alignment of liquid crystal molecules in each domain when an electric field is generated is controlled.

In the method as described above, however, when a voltage is OFF, some liquid crystal molecules not inclining in the vertical direction to the substrate surface and inclining in a direction with respect to the substrate surface are present in a domain in which the protrusion for alignment control is provided. Because of the phenomenon, leakage of light occurs in the domain in which the protrusion for alignment control is provided, which lowers the contract (between brightness of a while pixel and that of a black pixel).

An object of the present invention is to provide a technique enabling stabilization of a domain center of liquid crystal molecules without depending on strength of an electric field, for instance, in a liquid crystal display device based on the VA system.

Another object of the present invention is to provide a technique enabling improvement in contract (between brightness of a while pixel and that of a black pixel) in a liquid crystal display device based on the VA system.

The above-described and other objects and features of the present invention will be clarified by referring to descriptions in the present specification and to the attached drawings.

Of the inventions disclosed in this patent application, outline of the representative ones is as described above.

(1) The present invention provides a liquid crystal display device having a liquid crystal display panel in which a liquid crystal material is held between a first substrate and a second substrate. In the liquid crystal display panel, liquid crystal molecules in the liquid crystal material is aligned in the vertical direction with respect to a surface of the substrate when a display is made in black; the second substrate has a first counter electrode; the first substrate has a pixel electrode, a protrusion for alignment control in which a surface of the protrusion facing against the second substrate partially protrudes, and a second counter electrode formed in the contrary side from the first counter electrode when viewed from the pixel electrode and having an electric potential different from an electric potential of the pixel electrode when a display is made in black as well as from that of the first counter electrode; the pixel electrode of the first substrate has a slit or an opening at a position where the protrusion for alignment control is formed; and at the same time, the second counter electrode extends at a position overlapping with the slit or the opening of the pixel electrode.

(2) The present invention provides the liquid crystal display device as described in (1) above, and in the liquid crystal display device, the second counter electrode has a potential enabling an electric line of force generated between the second counter electrode and the pixel electrode when a display is made in black to pass through the slit or the opening of the pixel electrode.

(3) The present invention provides the liquid crystal display device as described in (1) or (2) above, and in the liquid crystal display device, the second counter electrode is a transparent electrode.

(4) The present invention provides the liquid crystal display device as described in any of (1) to (3) above, and in the liquid crystal display device, a holding capacitance is formed between the pixel electrode and the second counter electrode.

(5) The present invention provides a liquid crystal display device having a liquid crystal panel in which a liquid crystal material is held between a first substrate and a second substrate. In the liquid crystal display panel described above, liquid crystal molecules in the liquid crystal material is aligned in the vertical direction with respect to a surface of the substrate when a display is made in black; the second substrate has a first counter electrode; the first substrate has, in one pixel area, a first pixel electrode and a second pixel electrode, which have a different distance from the first counter electrode from each other; a step forming layer formed in a domain overlapping either one of the first pixel electrode or the second electrode, the one nearer to the first counter electrode; and a second counter electrode formed in the side opposite to the first counter electrode when viewed from the first pixel electrode and the second pixel electrode and having an electric potential different from an electric potential of the first pixel electrode and the second pixel electrode as well as from that of the first counter electrode when a display is made in black. Also, at an end portion of the step forming layer in the one pixel area, there is provided a domain overlapping neither the first pixel electrode nor the second pixel electrode. The second counter electrode extends in the domain of the end portion overlapping neither the first pixel electrode nor the second pixel electrode in a domain in which the first pixel electrode is formed and also in a domain in which the second pixel electrode is formed.

(6) The present invention provides a liquid crystal display device as described in (5) above, and in the liquid crystal display device, the second counter electrode has an electric potential enabling an electric line of force generated between the second counter electrode and the first pixel electrode or the second pixel electrode when a display is made in black to pass the domain at the end portion of the step forming layer overlapping neither the first pixel electrode nor the second pixel electrode.

(7) The present invention provides a liquid crystal display device as described in (5) or (6), and in the liquid crystal display device, the second counter electrode is a transparent electrode.

(8) The present invention provides a liquid crystal display device as described in any of (5) to (7), and in the liquid crystal display device, the first substrate forms a holding capacitance between the first pixel electrode or the second pixel electrode and the second counter electrode.

(9) The present invention provides a liquid crystal display device as described in any of (5) to (8) above, and in the liquid crystal display device, the first substrate has a protrusion for alignment control in which a surface of the substrate facing against the second substrate partially protrudes; the first pixel electrode or the second pixel substrate has a slit or an opening at a position where the protrusion for alignment control is formed; and the second counter electrode extends at a position overlapping the slit or the opening of the first pixel electrode or the second pixel electrode.

One of the liquid crystal display devices according to the present invention has a liquid crystal display panel in which a liquid crystal material is held between a first substrate and a second substrate, and liquid crystal molecules in the liquid crystal material are aligned in the vertical direction with respect to a surface of the substrate when a display is made in black. In this configuration, the second substrate has a first counter electrode, and the first substrate has a pixel electrode, a protrusion for alignment control in which a surface of the substrate facing against the second substrate partially protrudes, and a second counter electrode provided in the contrary direction from the first counter electrode when viewed from the pixel electrode and also having a potential from a potential of the pixel electrode as well as from that of the first counter electrode when a display is made in black. In this configuration, the pixel electrode of the first electrode has a slit or an opening at a position where the protrusion for alignment control is provided, and the second counter electrode extends in the slit or the opening of the pixel electrode.

In the configuration as described above, an electric flux line generated between the pixel electrode and the second counter electrode when a display is made in black passes through the slit or the opening of the pixel electrode, and the electric field leaks between the pixel electrode and the first counter electrode in the domain in which the protrusion for alignment control is provided. Because of this phenomenon, when a display is made in black, due to the leaked electric field, alignment of liquid crystal molecules in the domain in which the protrusion for alignment control is provided fluctuates from the vertical direction with respect to an inclined surface of the protrusion to the substantially vertical direction with respect to the substrate surface. As a result, leakage of light, which occurs when a display is made in black in the domain in which the protrusion for alignment control is provided, can be reduced with the contrast (brightness of a white pixel/brightness of a black pixel) improved.

By providing the protrusion for alignment control, the domain center of liquid crystal molecules generated between a pixel electrode provided at a position and a pixel electrode provided at a position adjacent to the position at which the pixel electrode is provided, that is, a position at which inclination of the liquid crystal molecules changes does not depend on strength of an electric field generated between the pixel electrode and the first counter electrode and stabilizes. Because of this feature, a liquid crystal domain controlled by the pixel electrode becomes constant for all pixels on a liquid crystal display panel, so that non-uniformity in brightness is suppressed and a display not causing the sense of discomfort can be provided.

By providing the first substrate and the second counter electrode, a holding capacitance can be formed between the pixel electrode and the second counter electrode. Because of this feature, freedom in designing becomes higher, which facilitates designing of a high precision fine panel.

In this case, the second counter electrode is preferably provided not only around the protrusion for alignment control, but also on the entire surface of the substrate. Because of this requirement, the second counter electrode is preferably a transparent electrode.

The liquid crystal display device according to the present invention may have a step forming layer and a display panel having a first pixel electrode and a second pixel electrode which have a different distance from the first counter electrode from each other like in the case of semi-transparent liquid crystal display panel. In this case, an inclined face like the protrusion for alignment control is present at an end portion of the step forming layer in one pixel area. Because of this configuration, when a display is made in black, liquid crystal molecules aligned in the substantially vertical to the inclined face are preset around the end portion of the step forming layer, and light leakage occurs at this portion to lower the contrast (between brightness of a white pixel and that of a black pixel). To overcome this problem, in the liquid crystal display device according to the present invention, a domain including neither a first pixel electrode nor a second pixel electrode is provided, and at the same time the second counter electrode is provided.

In this configuration, the electric flux line generated, when a display is made in black, between the first and second pixel electrodes and the second counter electrode passes through a domain including no pixel electrode around an end portion of the step forming layer, and the electric field leaks in the end portion area of the step forming layer to a section between the pixel electrode and the first counter electrode. Because of this feature, when a display is made in black, because of the leaked electric field, alignment of liquid crystal molecules in a domain, in which the protrusion for alignment control is provided, changes from the vertical direction to the inclined face of the protrusion to the substantially vertical direction with respect to the substrate surface. As a result, light leakage which occurs, when a display is made in black, in the domain where the protrusion for alignment control is provided, decreases with the contract (brightness of a white pixel/brightness of a black pixel) improved.

Also in the semi-transparent liquid crystal display panel as described above, the configuration is allowable in which the protrusion for alignment control as described above is provided, a slit or an opening for a pixel electrode is provided in a domain overlapping the protrusion for alignment control, and the second counter electrode extends in the slit or the opening of the pixel electrode. With this configuration, light leakage occurring, when a display is made in black, in a domain in which the protrusion for alignment control is provided can be reduced and the contrast (between brightness of a white pixel and that of a black pixel) can be improved.

By providing the protrusion for alignment control, the domain center of liquid crystal molecules generated between a pixel electrode provided at a position and a pixel electrode provided at the adjacent position, namely a position at which inclination of the liquid crystal molecules changes does not depend on strength of an electric field generated between the pixel electrode and the first counter electrode and stabilizes. Because of the feature, an liquid crystal domain controlled by the pixel electrode becomes constant for all pixels on a liquid crystal display panel, so that non-uniformity in brightness is suppressed and a display not causing the sense of discomfort can be provided.

By providing the first substrate and the second counter electrode, a holding capacitance can be formed between the pixel electrode and the second counter electrode. Because of this feature, freedom in designing becomes higher, which facilitates designing of a high precision fine panel.

In this case, the second counter electrode is preferably provided not only around the protrusion for alignment control, but also on the entire surface of the substrate. Because of this requirement, the second counter electrode is preferably a transparent electrode.

### BRIEF DESCRIPTION OF THE DRAWINGS

FIG. 1 is a plan view illustrating a general configuration of a liquid crystal display panel;

FIG. 2 is a cross-sectional view taken along the line A-A′ of FIG. 1;

FIG. 3 is a plan view illustrating an example of a configuration of one pixel in the liquid crystal display panel according to a first embodiment of the present invention;

FIG. 4 is a cross-sectional view taken along the line B-B′ of FIG. 3;

FIG. 5 is a cross-sectional view taken along the line C-C′ of FIG. 3, and illustrates alignment of liquid crystal molecules when a display is made in black;

FIG. 6 is a cross-sectional view taken along the line C-C′ of FIG. 3, and illustrates alignment of liquid crystal molecules when a difference in potential is generated between a pixel electrode and a counter electrode of a counter substrate;

FIG. 7 is a view illustrating a result of a simulation for effects of the liquid crystal display panel according to the first embodiment;

FIG. 8 is a graph illustrating a relation between an electric potential of a common electrode and a transmittance when a width of an opening of a pixel electrode is changed;

FIG. 9 is a plan view illustrating an example of a configuration of one pixel in a liquid crystal display panel according to a second embodiment of the present invention;

FIG. 10 is a cross-sectional view taken along the line D-D′ of FIG. 9, and illustrates alignment of liquid crystal molecules when a display is made in black;

FIG. 11 is a plan view illustrating an example of a configuration of one pixel in a liquid crystal display panel according to a third embodiment of the present invention;

FIG. 12 is a cross-sectional view taken along the line E-E′ of FIG. 11, and illustrates alignment of liquid crystal molecules when a display is made in black; and

FIG. 13 is a cross-sectional view taken along the line F-F′ of FIG. 11, and illustrates alignment of liquid crystal molecules when a display is made in black.

### DETAILED DESCRIPTION OF THE PREFERRED EMBODIMENTS

Embodiments of the present invention are described in detail below with reference to the drawings.

The same reference numeral is assigned to sections having the same function in all of the figures for describing the embodiments, and repetitive description thereof is omitted.

### First Embodiment

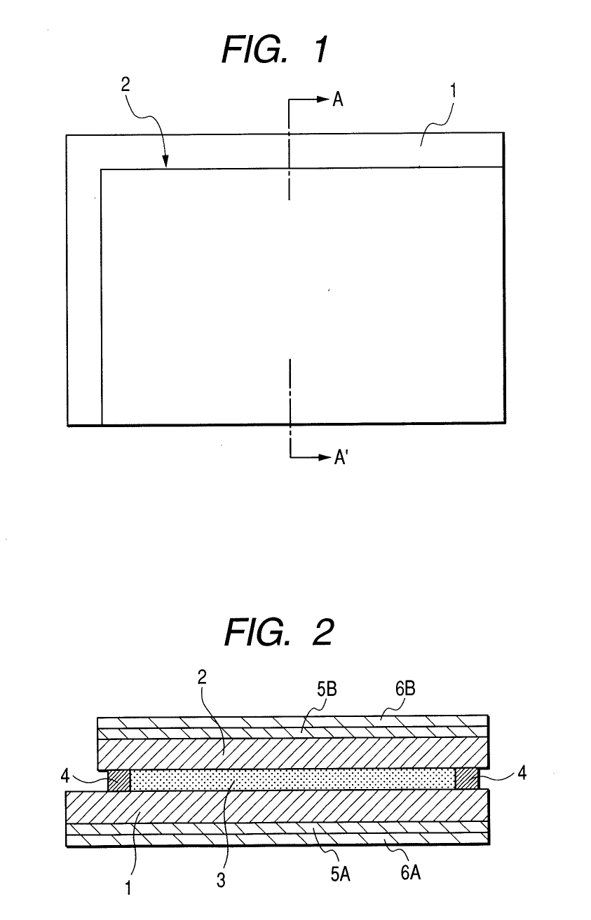

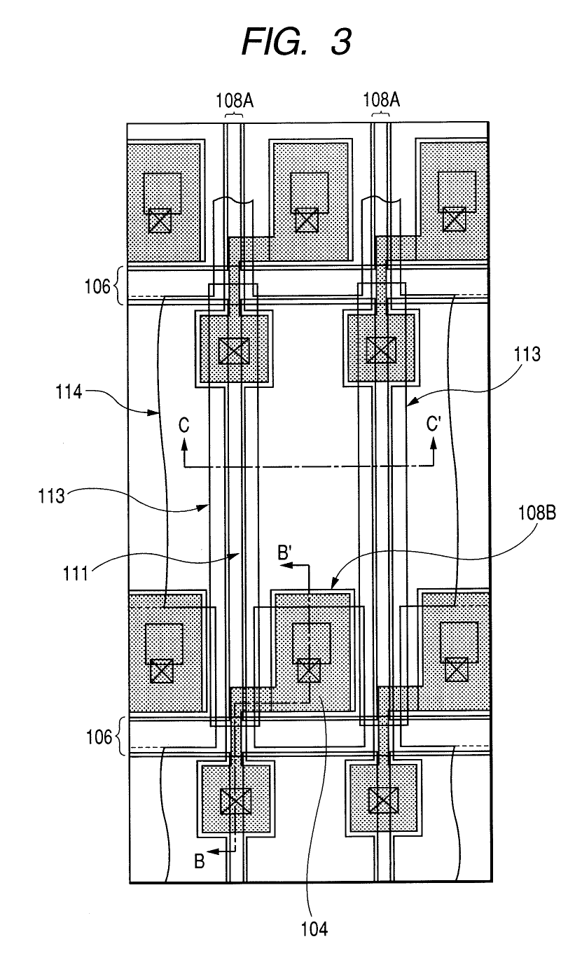

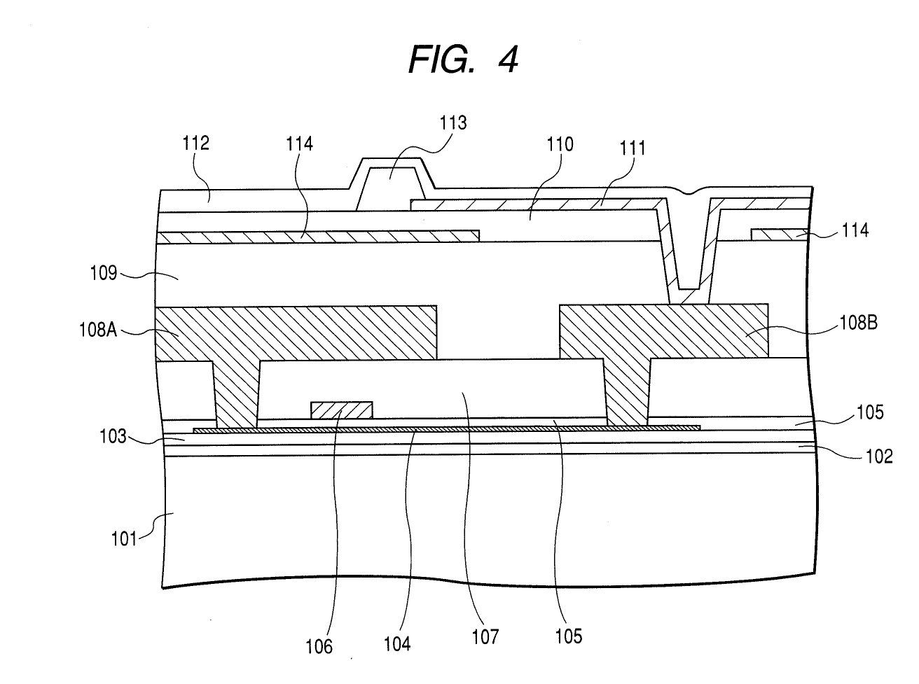

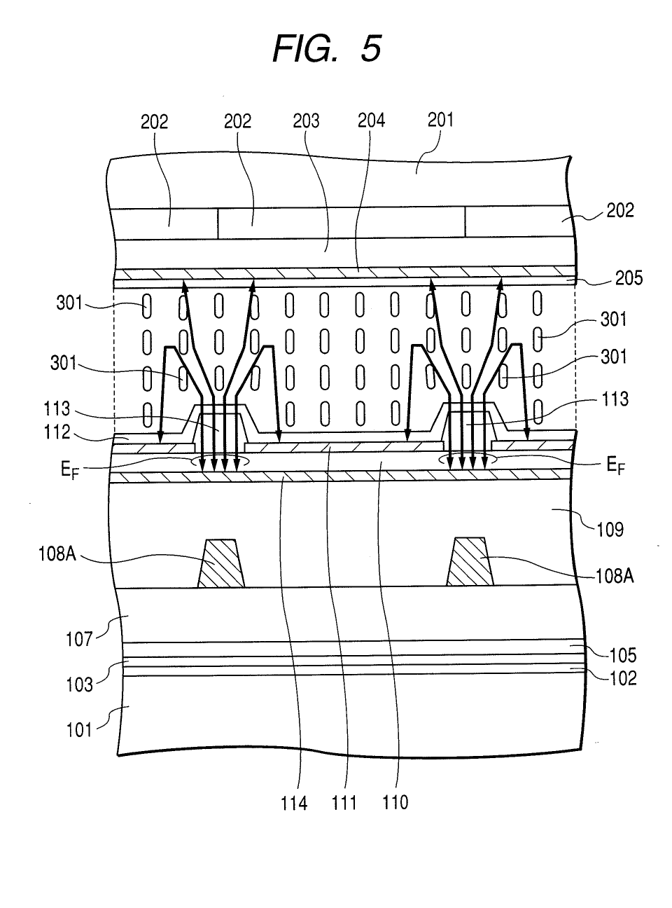

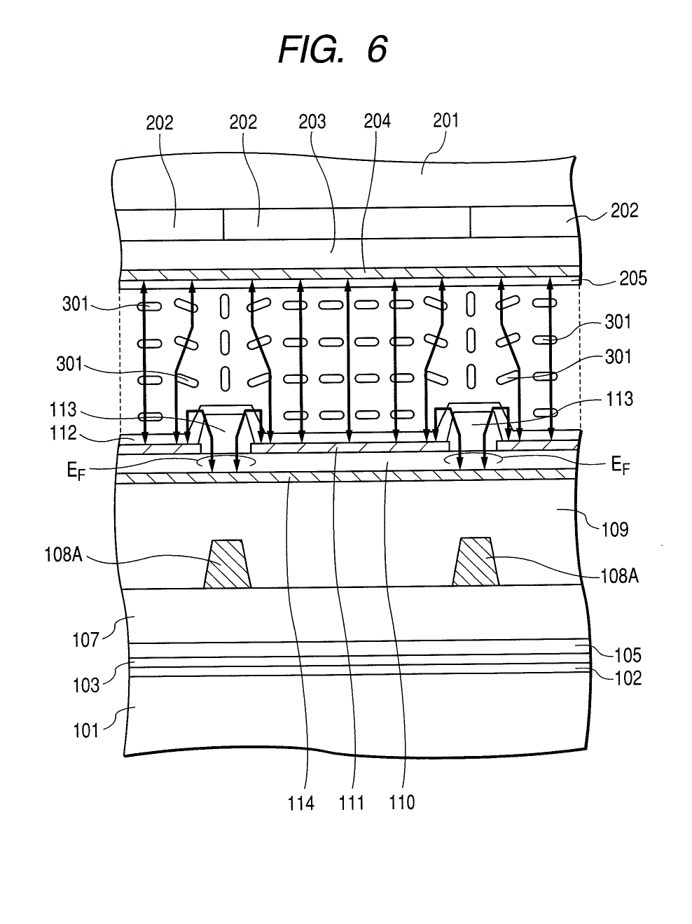

FIGS. 1 to 6 are schematic views each illustrating a general configuration of a liquid crystal display device according to a first embodiment of the present invention. FIG. 1 is a plan view illustrating a general configuration of a liquid crystal display panel. FIG. 2 is a cross-sectional view taken along the line A-A′ of FIG. 1. FIG. 3 is a plan view illustrating an exemplary configuration of the liquid crystal display panel according to the first embodiment. FIG. 4 is a cross-sectional view taken along the line B-B′ of FIG. 3. FIG. 5 is a cross-sectional view taken along the line C-C′ of FIG. 3 and illustrates alignment of liquid crystal molecules when a display is made in black. FIG. 6 is a cross-sectional view taken along the line C-C′ of FIG. 3, and illustrates alignment of liquid crystal molecules when a potential difference is generated between a pixel electrode and a counter electrode on a counter substrate.

The liquid crystal display device according to the first embodiment has, as shown in FIG. 1 and FIG. 2, a liquid crystal display panel in which a liquid crystal material (a liquid crystal layer) 3 is held between a pair of substrates 1, 2. In this configuration, the pair of substrates 1, 2 are adhered to each other with a circular sealing material 4, and the liquid crystal layer 3 is sealed in a space surrounded by the substrates 1, 2 and the sealing material 4.

Of the pair of substrates 1, 2, the substrate 1 has a scan signal line (also referred to as a gate signal line), a video signal line (also referred to as a drain signal line), a TFT element, an pixel electrode, an alignment film and the like each formed, for instance, on a surface of the glass substrate, and the substrate 1 is also referred to as a TFT substrate.

The other substrate 2 has a counter electrode (also referred to as common electrode), a color filter, an alignment film, and the like each formed, for instance, on a surface of the glass substrate, and the substrate 2 is also referred to as a counter substrate.

Furthermore, for instance, a wave plate 5A and a deflecting plate 6A are arranged in a rear face of the surface of the TFT substrate facing against the counter substrate 2. A wave plate 5B and a deflecting plate 6B forming a pair with the wave plate 5A and the deflecting plate 6A on the TFT substrate 1 are arranged on a rear face of the surface of the counter substrate 2 facing against the TFT substrate 1. In the following descriptions, the wave plate 5A and the deflecting plate 6A arranged on the TFT substrate 1 are referred to as a lower wave plate and lower defection plate, respectively, while the wave plate 5B and the defection plate 6B arranged on the counter substrate 2 are referred to as a upper wave plate and lower deflecting plate, respectively.

In the liquid crystal display panel according to the first embodiment, the upper circular deflecting plate is formed by combining the upper deflecting plate 6B and the upper wave plate 5B on the counter substrate 2, while the lower circular deflecting plate is formed by combining the lower deflecting plate 6A and the lower wave plate 5A on the TFT substrate 1. In this arrangement, the upper circular deflecting plate and the lower circular deflecting plate are arranged to sandwich the liquid crystal layer, and the angle of the upper deflecting plate and the angle of the lower circular deflecting plate are different by 90 degrees from each other.

An example of a configuration of one pixel in the liquid crystal display panel having the configuration as described above is described below. In the first embodiment, a transmission color liquid crystal display panel based on the VA system is described.

In the first embodiment, a configuration of one pixel of the liquid crystal display panel is, for instance, as shown in FIG. 3 to FIG. 5. FIG. 3 illustrates a configuration of one pixel of the TFT substrate. FIG. 4 illustrates a cross-sectional configuration of the TFT substrate 1 taken along the line B-B′ of FIG. 3. FIG. 5 illustrates cross-sectional configurations of the TFT substrate 1, counter substrate 2, and liquid crystal layer 3 taken along the line C-C′ of FIG. 3.

In the liquid crystal display panel according to the first embodiment, the TFT substrate 1 has a configuration, for instance, in which a semi-conductor layer 104 is provided via a first insulating layer 102 and a second insulating layer 103 on a surface of a glass substrate 101. This semi-conductor layer 104 is formed by forming a film with, for instance, polysilicon and subjecting the film to a patterning process. In addition, a scan signal line 106 is provided via a third insulating layer 105 on the semi-conductor layer 104. The scan signal line 106 is patterned so that a portion of the signal line 106 overlaps the semi-conductor layer 104, and the overlapping area functions as a gate for the TFT elemental device.

A video signal line 108A and a source electrode 108B are provided via a fourth insulating layer 107 on the scan signal line 106. The video signal line 108A is electrically connected via a through hole to the semi-conductor layer 104, and functions as a drain for the TFT element. Furthermore, also the source electrode 108B is electrically connected via a through hole to the semiconductor layer 104, and functions as a source for the TFT element.

A pixel electrode 111 is provided via a fifth insulating layer 109 and a sixth insulating layer 110 on the video signal line 108A and the source electrode 108B respectively. The pixel electrode 111 is electrically connected via a through hole to the source electrode 108B. Furthermore an alignment film 112 is provided on the pixel electrode 111.

In the liquid crystal display panel according to the first embodiment, a protrusion 113 for alignment control formed by protruding a surface of a substrate (an alignment film 112) toward a counter substrate is provided (in a slit) between two pixel electrodes 111 arranged in pixel areas adjacent to each other with the video signal line 108A in between.

Furthermore, on the TFT substrate 1, a common electrode (counter electrode) 114 is provided via the sixth insulating layer 110 in the contrary side from the counter substrate 2 when viewed from the pixel electrode 111. This common electrode 114 is provided, as shown in FIG. 5, so that the common electrode 114 extends through a section (slit) between the two pixel electrodes 111 provided in the pixel areas adjacent to each other with the video signal 108A in between.

One pixel on the TFT substrate 1 is a domain surrounded by the two video signal lines 108A adjacent to each other and the two scan signal lines 106 adjacent to each other, and configurations each based on this pixel are cyclically arranged two-dimensionally on the TFT substrate 1.

A configuration of the one pixel on the TFT substrate 1 shown in FIG. 3 to FIG. 5 is only one example, and a configuration of one pixel is not limited to that described above, and it is needless to say that other configurations are allowable.

On the other hand, a color filter 202 is provided, for instance, on a surface of the glass substrate 201. In the case of a color liquid crystal display panel, the one pixel shown in FIG. 3 is referred to as “sub-pixel”, and one dot of an image is formed with a plurality of sub-pixels. For the color filter 202 for the counter substrate 2, for instance, filters for a red color (R), a green color (G), and a blue (B) are cyclically arranged on discrete sub-pixels respectively. One dot is formed with three sub-pixels, namely a sub-pixel with a color filter for a red color provided thereon, a sub-pixel with a color filter for a green color provided thereon, and a sub-pixel with a color filter for a blue color provided thereon. Further the color filters 202 for three colors may be separated from each other, for instance, with a black matrix.

Furthermore, a counter electrode (common electrode) 204 is provided via an over coat layer 203 on the color filter 202. An alignment film 205 is provided on the counter electrode 204.

In the case of a liquid crystal display panel based on the VA system, in the liquid crystal layer 3 held between the TFT substrate 1 and the counter substrate 2, when the voltage is OFF, namely when a potential difference between the pixel electrode 111 and the counter electrode 204 is 0 (zero), as shown in FIG. 5, the liquid crystal molecules 301 are aligned in the vertical direction with respect to a surface of the substrate. Even when the voltage is OFF, in the domain with the protrusion 113 for alignment control provided thereon, alignment of liquid crystal molecules 301 is not vertical to the substrate surface, but is aligned in the substantially vertical to the inclined surface of the protrusion 113 for alignment control (alignment film 112).

In this step, in a domain in which the liquid crystal molecules 301 are inclined and aligned due to the protrusion 113 for alignment control, retardation occurs in the liquid crystal layer 3. The retardation, which occurs when the voltage is OFF, namely when a display is made in black, sometimes causes leakage of light, and as a result, the transmission contract expressed by a value obtained by dividing a transmittance when a display is made in white by a transmittance when a display is made in black (white transmittance/black transmittance) becomes lower.

To overcome this problem, in the liquid crystal display panel according to the first embodiment, an electric potential different from that in the pixel electrode 111 when a display is made in black and different from that in the counter substrate 204 of the counter substrate 2 is generated in the common electrode 114 of the TFT substrate 1. With the configuration, for instance, as shown in FIG. 5, a fringe electric field E_{F} is generated because of the difference in potential between the pixel electrode 111 and the common electrode 114, and a diagonal electric field is loaded to the liquid crystal layer 3. An electric potential of the common electrode 114 may always be constant, or may be varied to a prefixed potential at a point of time when a scan signal voltage is supplied to a scan signal line for a pixel to be driven.

In the liquid crystal display panel according to the first embodiment, when a display is made in black, as shown in FIG. 5, a diagonal electric field is applied to the liquid crystal layer 3, and therefore the liquid crystal molecules 301 in an outer peripheral portion of the protrusion 113 for alignment control are aligned in the substantially vertical direction to the substrate surface. Because of this feature, the liquid crystal molecules 301 in the entire domain of the pixel are aligned in the substantially vertical direction, which reduces leakage of light when a display is made in black. As a result, a transmittance (brightness) when a display is made in black becomes smaller, and the transmission contrast expressed by a value obtained by dividing a transmittance when a display is made in white by a transmittance when a display is made in black (white transmittance/black transmittance) becomes higher.

Furthermore the protrusion 113 for alignment control of the TFT substrate 1 plays a role for controlling alignment of the liquid crystal molecules 301 when an electric potential in the pixel electrode 111 becomes higher and, for instance, the fringe electric field E_{F} generated by the pixel electrode 111 and the common electrode 114 is mitigated as shown in FIG. 6. This phenomenon contributes to stabilization of a point at which alignment of the liquid crystal molecules 301 changes (domain center), which enables suppression of fluctuation of the domain center dependent on strength of an electric field corresponding to a difference in potential between the pixel electrode 111 and the counter electrode 204. Because of this feature, non-uniformity of brightness due to movement of a domain center can be reduced.

By providing the common electrode 114 on the TFT substrate 1, a holding capacitance can be formed between the pixel electrode 111 and the common electrode 114. In this step, if a transparent electrode is used as the common electrode 114 in this step, a holding capacitance can be formed in a display domain for each pixel, namely a light-transmissible domain. Because of this feature, a freedom degree in designing becomes higher, which facilitates designing of a highly precise and fine panel.

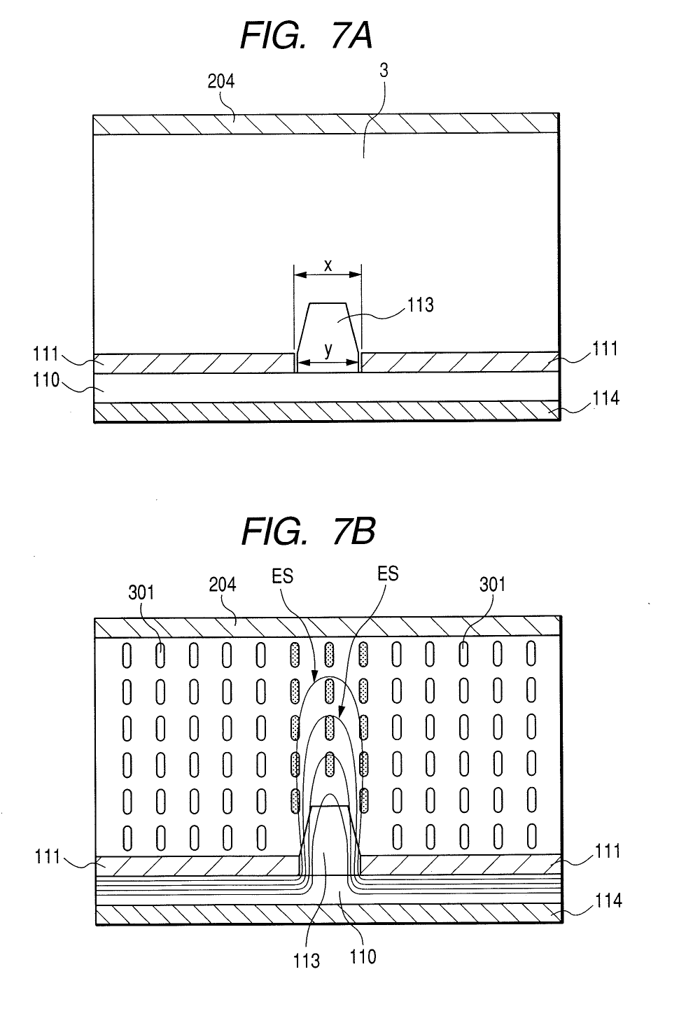

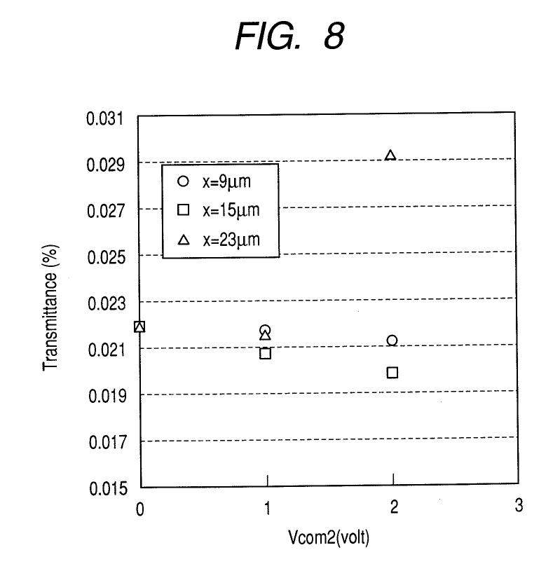

FIG. 7 and FIG. 8 are schematic views supplementarily illustrating effects of the liquid crystal display panel according to the first embodiment. FIG. 7 is a view illustrating a result of simulation for effects of the liquid crystal display panel according to the first embodiment. FIG. 8 is a graph showing a relation between an electric potential of a common electrode and a transmittance when a width of an opening of a pixel electrode is changed. In FIG. 7, FIG. 7A illustrates a structural model of a liquid crystal panel used for the simulation, and FIG. 7B illustrates alignment of liquid crystal molecules and an equipotential line obtained as a result of the simulation.

To investigate the effects of the liquid crystal display panel according to the first embodiment, distribution of alignment of liquid crystal molecules and the equipotential line were simulated by using the structure model as shown in FIG. 7A. In the structural model shown in FIG. 7A, the sixth insulating layer 110 with a specific dielectric coefficient of 6.7 is arranged on the common electrode 114 not having been subjected to patterning, and the pixel electrode 111 with an opening thereon is arranged on the sixth insulating layer 110. The protrusion 113 for alignment control with a height of 1 μm and a width of 15 μm (y=15 μm) is arranged in the opening of the pixel electrode 111. The negative type liquid crystal layer 3 is arranged on the pixel electrode 111 as well as on the protrusion 113 for alignment control, and furthermore the counter electrode 204 is provided on the liquid crystal layer 3. An anisotropic refraction factor Δn of the negative type liquid crystal layer 3 is 0.1, and an anisotropic dielectric coefficient thereof is −5. In the actual liquid crystal display panel, the alignment films 112 and 205 are present between the pixel electrode 111 and the liquid crystal layer 3 and between the counter electrode 204 and the liquid crystal layer 3, respectively. However, since presence of the alignment film has only a small influence on alignment of liquid crystal molecules and distribution of the equipotential line, the alignment film is ignored in the structural model.

In this simulation, if a width x of the opening of the pixel electrode 111 is set, for instance, to 15 μm, potentials of the pixel electrode 111 and the counter electrode 204 to 0 V, and a potential of the protrusion 113 for alignment control to 2 V, alignment of the liquid crystal molecules 301 and distribution of the equipotential line ES are as shown in FIG. 7B. As understood from the simulation results, the equipotential line ES generated between the pixel electrode 111 and the common electrode 114 substantially expands toward the counter electrode 204 in the opening of the pixel electrode 111. In other words, a diagonal electric field passing through the liquid crystal layer 3 is generated around the opening of the pixel electrode 111. Because of the electric field, if there is not the common electrode 114, inclination of the liquid crystal molecules aligned in the substantially vertical direction to the outer peripheral portion (inclined surface) of the protrusion 113 for alignment control changes to a direction vertical to a surface of the substrate (a surface of the pixel electrode 111) because of the presence of the common electrode 114.

Changes of a transmittance are investigated by setting a width y of the protrusion 113 for alignment control, for instance, to 15 μm, potentials of the pixel electrode 111 and the counter electrode 204 to 0 V and also by changing a width x of the opening of the pixel electrode 111 and a potential of the common electrode 114, and the results of the investigation are, for instance, as shown in FIG. 8. In the graph shown in FIG. 8, the horizontal axis is plotted with a potential of the common electrode 114 (V com2), while the vertical axis is plotted with a transmittance when a display is made in black. As an example of the case in which the width x of the opening of the pixel electrode 111 is smaller than the width y of the protrusion for alignment control, when the width x of the pixel electrode 111 is set to 9 μm, namely when a difference in potential between the pixel electrode 111 or the counter electrode 204 and the common electrode 114 is 2 V, the transmittance when a display is made in black becomes lower as compared with that in the case where the common electrode 114 is not present. In the case where the width x of the opening of the pixel electrode 111 is identical to the width y of the width y of the protrusion 113 for alignment control (when x is 15 μm), when a difference in potential between the pixel electrode 111 or the counter electrode 204 and the common electrode 114 is 1 V, a transmittance when a display is made in black becomes lower. Furthermore, in the case where the width x of the opening of the pixel electrode 111 is identical to the width y of the width y of the protrusion 113 for alignment control, when a difference in potential between the pixel electrode 111 or the counter electrode 204 and the common electrode 114 is 2 V, the transmittance when a display is made in black becomes further lower.

On the other hand, as a case where the width x of the opening of the pixel electrode 111 is larger than the width y of the protrusion 113 for alignment control, when the width x of the opening of the pixel electrode 111 is set to 23 μm, if a difference in potential between the pixel electrode 111 or the counter electrode 204 is 1 V, a transmittance when a display is made in black becomes slightly lower, but if the difference in potential is 2 V, the transmittance becomes higher.

As a result, in the liquid crystal display panel according to the present invention, it is conceivably desirable to set both a space between the adjacent pixel electrodes 111 and the width of the protrusion 113 for alignment control to 15 μm and a difference in potential between the pixel electrode 111 or the counter electrode 204 and the common electrode 114 to 2 V.

As understood from the graph shown in FIG. 8, the effect for lowering a transmittance when a display is made in black by a diagonal electric field varies according to a relation between the width x of the opening of the pixel electrode 111 and the width y of the protrusion 113 for alignment control as well as to a difference in potential between the pixel electrode 111 and the counter electrode 204 when a display is made in black. In the actual liquid crystal display panel, such a parameter as a space between adjacent pixel electrodes 111 varies from product to product. Therefore, in the actual liquid crystal display panel, based on such parameters as a space between the adjacent pixel electrodes 111, a width of the protrusion 113 for alignment control and a difference in potential between the pixel electrode 111 or the counter electrode 204 and the common electrode 114 when a display is made in black may be changed if necessary.

A method of manufacturing the liquid crystal display panel according to the first embodiment is described below. When the liquid crystal display panel according to the first embodiment is manufactured, at first, the TFT substrate 1 and the counter substrate 2 are manufactured.

When manufacturing the TFT substrate 1 for the liquid crystal display panel according to the first embodiment 1, the steps up to formation of the fifth insulating layer 109 are the same as those employed in the conventional technology for manufacturing a TFT substrate, and therefore detailed description thereof is omitted herefrom.

When forming the fifth insulating layer 109, at first a surface-planarized insulating film (for instance, a polymethyl siloxane film) is formed. When this surface-planarized insulating film is formed, at first, for instance, organic resin made of polymethyl silazan is applied on a glass substrate with the video signal line 108A and the source electrode 108B having been formed thereon by means of the spin coat method. When the glass substrate is exposed to an i-ray by using a photo mask with a desired pattern drawn thereon and is wet, silanol is formed on the exposed portion, and the silanol is removed with an alkali developer. In this step, for instance, a contact hole for connection between the source electrode 108B and the pixel electrode 111 is removed. Then, when the entire surface is exposed to g-h-i rays and is wet again, silanol is formed on portions not having been removed with the alkali developer before. Polymethyl siloxane (surface-planarized insulating film) is formed on a desired portion by sintering the silanol. In this step, the fifth insulating layer 109 is formed so that the film thickness after sintering is, for instance, 1 μm.

When the fifth insulating layer 109 is formed, then the common electrode 114 is formed. The common electrode 114 is formed, for instance, by subjecting an ITO film formed by sputtering to patterning. In this process, the ITO film is formed, for instance, with a thickness of about 77 nm. In the process for subjecting the ITO film to patterning, at first, for instance, a photo-sensitive resist is applied to the ITO film, and then the ITO film is exposed to light by using a photo mask with a desired pattern drawn thereon, and then the photo-sensitive resist is partially removed with an alkali developer to form an etching resist. In the case where a photo-sensitive resist is of a positive type, the exposed portion is removed. After the etching resist is formed, unnecessary portions of the ITO film are removed by using the resist as a mask and with an ITO etching liquid such as oxalic acid. Then, the etching resist is removed by using, for instance, a resist separation liquid such as MEA (monoethanolamine). When subjecting the common electrode 114 to patterning, patterning is performed so that a domain overlapping the pixel electrode described below and a section (slit) between adjacent pixel electrodes 111 are left, and the ITO film around a contact hole for connection between the source electrode 108B and the pixel electrode 111 is removed.

Then the sixth insulating layer 110 is formed on the common electrode 114. The sixth insulating layer 110 is formed, for instance, by processing a CVD film made of SiN (with a dielectric constant of 6.7) into one with a thickness of about 300 nm. After the SiN film is formed, the film is subjected to dry-etching with a gas such as SF₆+O₂ or CF₄ to form a contact hole for connection between the source electrode 108B and the pixel electrode 111.

Then the pixel electrode 111 is formed on the sixth insulating layer 110. Like in the case of common electrode 114, also the pixel electrode 111 is formed by subjecting an ITO film formed by means of sputtering to patterning. When patterning is performed to form the pixel electrode 111, etching is formed so that a rectangular electrode is left along a pixel area.

Then, the protrusion 113 for alignment control is formed in a section between adjacent pixel electrodes 111 (slit). To form the protrusion 113 for alignment control, for instance, photo-sensitive resin is applied to the pixel electrode 111 and to the sixth insulating layer 110, and then the applied resin is exposed to light by using a photo mask with a desired pattern drawn thereon, and is partially removed with an alkali developer. In this process, irregularities on a surface of the protrusion 113 for alignment control can be controlled by adjusting conditions for sintering the photo-sensitive resin. In the first embodiment, the photo-sensitive resin is sintered by heating the resin for 60 minutes in an atmosphere at a temperature of 230° C. The protrusion 113 for alignment control is formed to have a thickness of 1.0 μm after sintering.

Then the alignment film 112 is formed. For instance, the alignment film 112 for the VA system is printed on the pixel electrode 111 and the protrusion 113 for alignment control by using a resin plate with a desired pattern drawn thereon as a mask, and the printed alignment film 112 is sintered. The alignment film 112 is sintered, for instance, by heating the film for 10 minutes in an atmosphere at a temperature of 230° C. The TFT substrate 1 is prepared through the processing sequence as described above.

The counter substrate can be prepared according to the same processing sequence as that for preparing the conventional counter substrates, and therefore detailed description thereof is not provided herein.

When a liquid crystal display panel is prepared using the TFT substrate 1 and the counter substrate 2 obtained as described above, the liquid crystal material 3 is vacuum-encapsulated in a portion between the TFT substrate 1 and the counter substrate 2. When vacuum-encapsulating the liquid crystal material 3, a gap (cell gap) between the TFT substrate 1 and the counter substrate 2 is adjusted with a sealing material and a spacer (SOC) to 4.0 μm, and a negative type liquid crystal with a refraction index anisotropy Δn of 0.10 is vacuum-encapsulated in the cell gap. In this process, the liquid crystal molecules 301 are aligned in the vertical direction with respect to a surface of the substrate according to an alignment restricting force provided by the alignment films 112, 204 for the VA system. In the domain in which the protrusion 113 for alignment control is provided, the liquid crystal molecules 301 are aligned in the substantially vertical direction to an inclined face of the protrusion 113 for alignment control (alignment film 112).

Then, an upper wave plate 5B and an upper deflecting plate 6B are adhered to the counter substrate 2, and a lower wave plate 5A and a lower deflecting plate 6A are adhered to the TFT substrate 1. The upper circular deflecting plate formed with the upper deflecting plate 6B and the upper wave plate 5B and the lower circular deflecting plate formed with the lower deflecting plate 6A and the lower wave plate 5A are arranged to sandwich the liquid crystal layer, and the angle of the upper deflecting plate and the angle of the lower circular deflecting plate are different by 90 degrees from each other.

More specifically, a Z-axial wave plate with a retardation Δn·d of 110 nm (when inclined by 45 degrees with respect to a main surface of the substrate), a uniaxial drawing wave plate with a retardation Δn·d of 140 nm (λ/4 wave plate), and a uniaxial drawing wave plate with a retardation Δn·d of 270 nm (λ/2 wave plate) are adhered in this order when viewed from the glass substrate 201 of the counter substrate 2 to the upper wave plate 5B. The λ/4 wave plate is adhered with a delayed phase axis angle of 175 degrees, and the λ/2 wave plate with a delayed phase axis angle of 55 degrees. The upper defecting plate 6B is adhered with a delayed phase axis angle of 160 degrees.

Furthermore, a Z-axial wave plate with a retardation Δn·d of 110 nm (when inclined by 45 degrees against a main surface of the substrate), a uniaxial drawing wave plate with a retardation Δn·d of 140 nm (λ/4 wave plate), and a uniaxial drawing wave plate with a retardation Δn·d of 270 nm (λ/2 wave plate) are adhered in this order when viewed from the glass substrate 101 of the counter substrate 2 to the lower wave plate 5A. The λ/4 wave plate is adhered with a delayed phase axis angle of 85 degrees, and the λ/2 wave plate with a delayed phase axis angle of 145 degrees. The lower defecting plate 6B is adhered with a delayed phase axis angle of 70 degrees.

It is to be noted that angles of the delayed phase axes of the wave plates 5A, 5B and the transmission axes of the deflecting plates 6A, 6B are expressed with values measured with respect to a predetermined direction as a reference, namely, for instance, measured in the counterclockwise direction with respect to the horizontal direction of a screen as a reference.

It is allowable that the Z-axial wave plate is not provided on the upper wave plate and on the lower wave plate 5A, but it is preferable to provide the Z-axial wave plate for insuring a wider field of view.

When manufacturing a transmission of liquid crystal display unit with the liquid crystal display panel according to the first embodiment, the same procedures as that employed for manufacturing a transmission liquid crystal display unit based on the conventional technology may be used, and therefore detailed description thereof is not provided herein.

As described above, in the liquid crystal display panel according to the first embodiment, a transmittance can be lowered by reducing light leakage when a display is made in black. As a result, the transmission contrast (transmittance when a display is made in white/transmittance when a display is made in black), in other words the contract expressed by a value obtained by dividing brightness when a display is made in white by brightness when a display is made in black) can be made higher.

Furthermore, by providing the protrusion 113 for alignment control, fluctuation of a domain center dependent on strength of an electric field according to a difference in potential between the pixel electrode 111 and the counter electrode 204 can be suppressed. Because of the feature, non-uniformity due to movement of a domain center can be reduced.

In addition, in the liquid crystal display panel according to the first embodiment, a holding capacitance can be formed between the pixel electrode 111 and the common electrode 114. When the common electrode 114 is a transparent electrode, a holding capacitance can be formed in a display domain of each pixel, namely in a light-transmissible domain. Because of this feature, a freedom degree in designing the TFT substrate becomes higher, which facilitates designing of a precise and fine panel.

### Second Embodiment

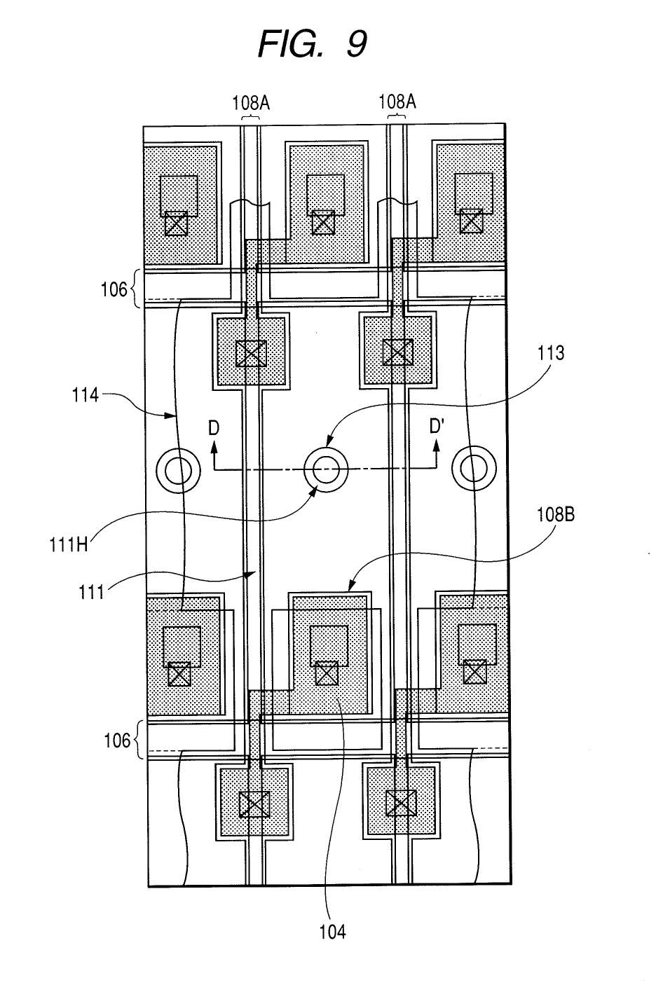

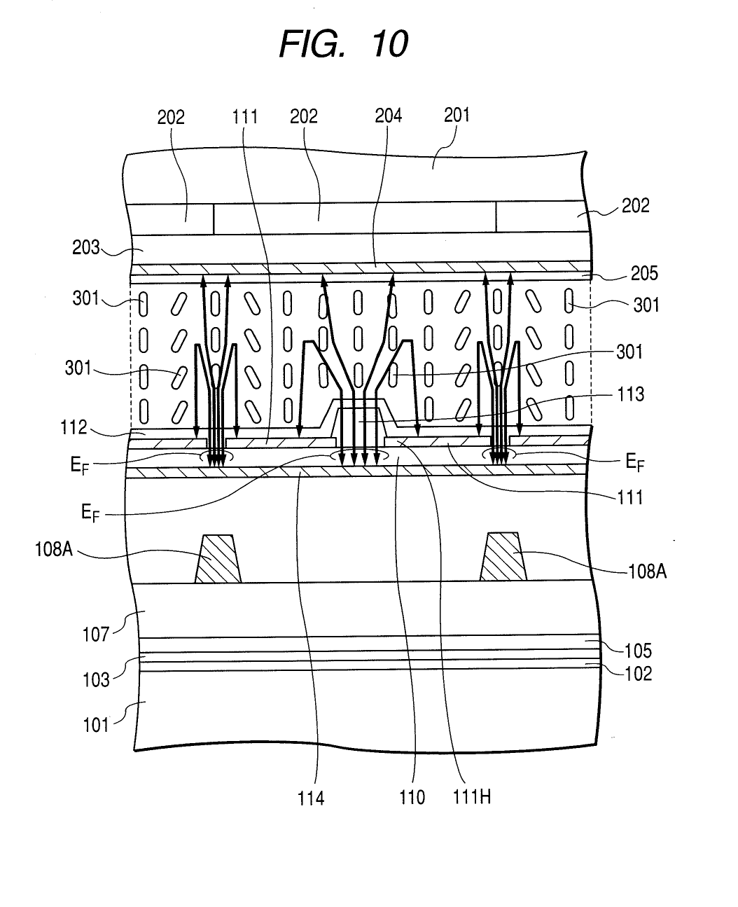

FIG. 9 and FIG. 19 are views each illustrating a general configuration of a liquid crystal display panel according to a second embodiment of the present invention. FIG. 9 is a plan view illustrating an example of a configuration of one pixel in the liquid crystal display panel according to the second embodiment. FIG. 10 is a cross-sectional view taken along the line D-D′ of FIG. 9, and illustrates alignment of liquid crystal molecules when a display is made in black.

In the liquid crystal display panel according to the first embodiment, alignment of liquid crystal molecules is controlled by providing the protrusion 113 for alignment control in a section (slit) between the adjacent two pixel electrodes 111, but a position of the pixel electrode 111 is not limited to that in the first embodiment, and the pixel electrode 111 may be provided at other positions. In the second embodiment, description is provided for an example of a configuration of a liquid crystal display panel in which the protrusion 113 for alignment control is provided at a substantially central portion of one pixel area (pixel electrode 111). The liquid crystal display panel described in the second embodiment is a transmission color liquid crystal display panel based on the VA system, and the basic configuration is the same as that of the liquid crystal display panel described in the first embodiment.

The TFT substrate 1 of the liquid crystal display panel according to the second embodiment has, as shown in FIG. 9 and FIG. 10, a semiconductor layer 104, a scan signal line 106, a video signal line 108A, a source electrode 108B, a pixel electrode 111 and the like each provided on a glass substrate. In this configuration, each of the pixel electrodes 111 has an opening 111H at a substantially central portion thereof, and the protrusion 113 for alignment control covers the opening 111H. Furthermore, the common electrode 114 is provided via the sixth insulating layer 110 in the contrary side from the counter substrate 2 (counter electrode 204) when viewed from the pixel electrode 111. In this configuration, the common electrode 114 extends in the opening 111H of each pixel electrode 111 and between adjacent two pixel electrodes.

In the example shown in FIG. 9, patterns of the opening 111H of each pixel electrode 111 and the protrusion 113 for alignment control are substantially circular when viewed from the top, but the pattern is not limited to the circular one, and also an oval or a polygonal pattern is allowable.

The counter substrate has the same configuration as that of the counter substrate 2 of the liquid crystal display panel according to the first embodiment, and a color filter 202, an overcoat layer 203, a counter electrode 204, and an alignment film 205 are laminated thereon.

In the case of the liquid crystal display panel based on the VA system, the liquid crystal layer 3 is, for instance, a negative type liquid crystal with the anisotropy in birefringence anisotropy Δn of 0.10. When a voltage is OFF, namely when a difference in potential between the pixel electrode 111 and the counter electrode 204 is 0 (zero), the liquid crystal molecules 301 are orientated in the vertical direction with respect to a surface of the substrate. In a domain in which the protrusion 113 for alignment control is provided, when a voltage is OFF, the liquid crystal molecules 301 are orientated in the substantially vertical direction with respect to an inclined face of the protrusion 113 for alignment control (alignment film 112).

Also in the case of the liquid crystal display panel according to the second embodiment, when a difference in potential between the pixel electrode 111 and the counter electrode 204 is zero, namely when the voltage is OFF (when a display is made in black), an electric potential different from that in the pixel electrode 111 and in the counter electrode 204 when a display is made in black is generated in the common electrode 114 of the TFT substrate 1. A relation between a potential in the pixel electrode 111 and in the counter electrode 204 and that in the common electrode 114 in this state is as described in the first embodiment. With this configuration, as shown, for instance, in FIG. 10, a fringe electric field E_{F} is generated in an opening of each pixel electrode 111, and a diagonal electric field is applied to the liquid crystal layer 3 around the opening (protrusion 113 for alignment control). Inclination of liquid crystal molecules which is in the substantially vertical to an outer peripheral section (an inclined surface) of the protrusion 113 for alignment control when the common electrode 114 is not present changes to the vertical direction to a surface of the substrate (a surface of the pixel electrode 111) because of the presence of the common electrode 114. As a result, light leakage generated, when a display is made in black, in a domain in which the protrusion 113 for alignment control is provided can be reduced, which in turn enables improvement in the transmission contrast.

In this step, the fringe electric field E_{F} is generated also between the adjacent two pixel electrodes 111. Because of the feature, as shown in FIG. 10, when the voltage is OFF, a domain center is generated at a border between the adjacent two pixel electrodes, so that inclination of the liquid crystal molecules 301 on each of the pixel electrodes 111 can be controlled.

Furthermore, in the liquid crystal display panel according to the second embodiment, when a voltage is turned ON and a difference in potential between the pixel electrode 111 and the counter electrode 204 is generated with an electric field generated, the liquid crystal molecules 301 in each pixel electrode 111 is inclined in the radial directions around the protrusion 113 for alignment control as a starting point (center). In this configuration, tilting angles of the liquid crystal molecules 301 are substantially identical at any azimuth, which enables prevention of non-uniformity in brightness due to differences in tinting angles.

Furthermore, also in the liquid crystal display panel according to the second embodiment 2, it is possible to form a holding capacitance between the pixel electrode 111 and the common electrode 114 by providing the common electrode 114 on the TFT substrate 1. In this process, when a transparent electrode is employed as the common electrode 114, the holding capacitance can be formed at a display domain, namely a light-transmissible domain of each pixel. Because of this feature, a freedom degree in designing the TFT substrate 1 increases, which facilitates designing of a precise and fine panel.

### Third Embodiment

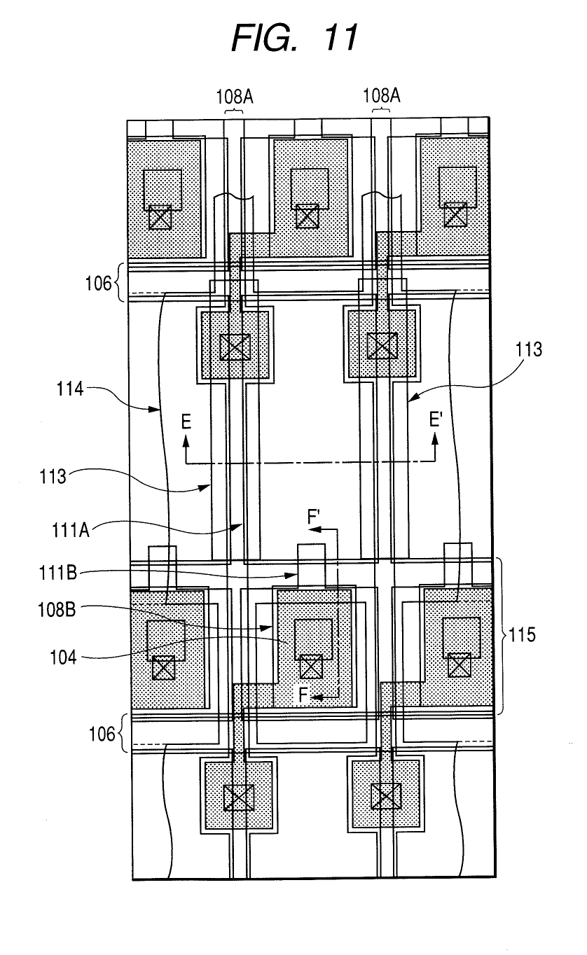

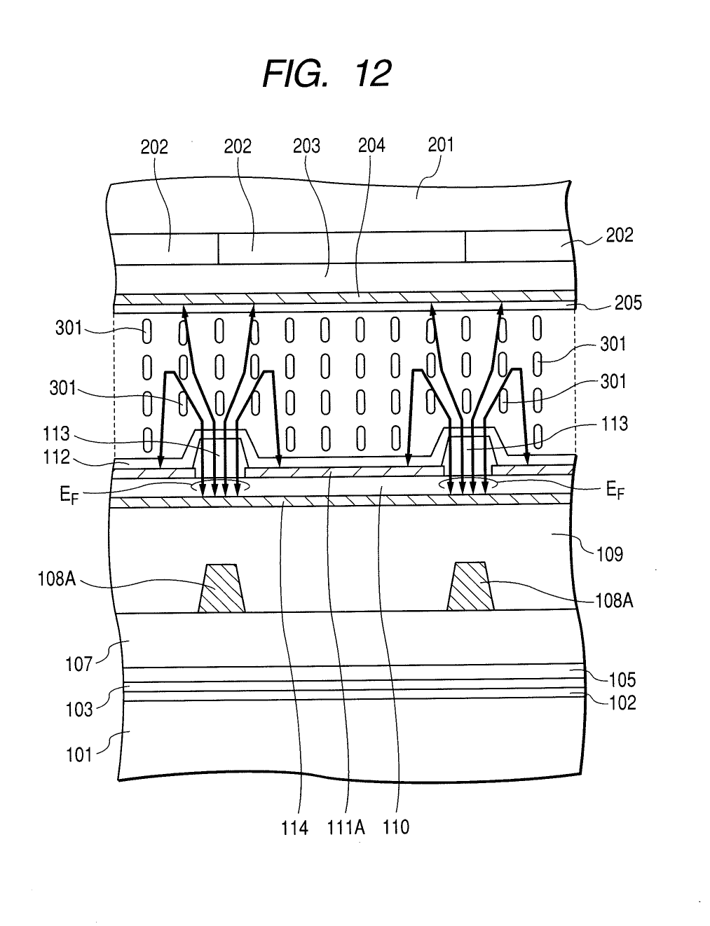

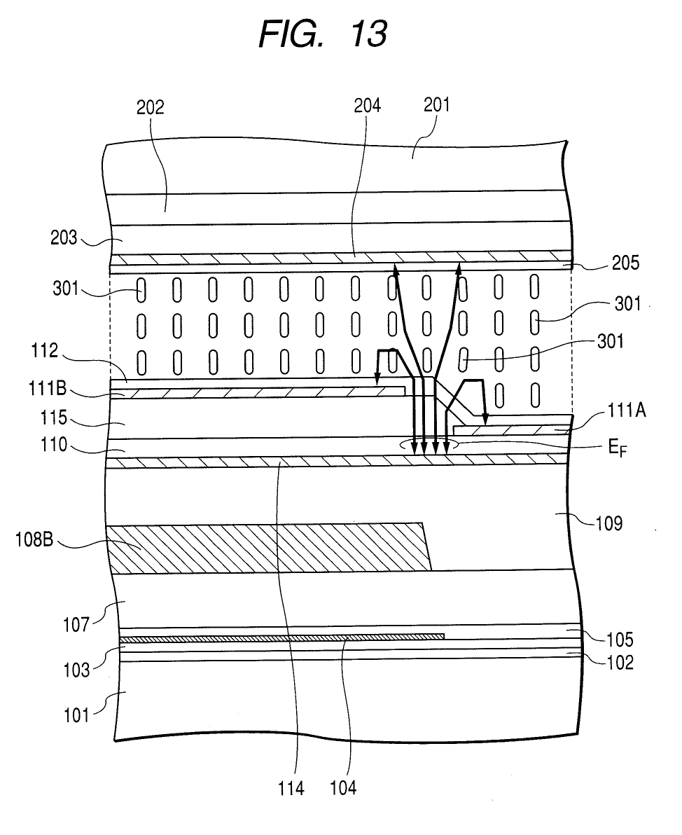

FIG. 11 to FIG. 13 are schematics views each illustrating a general configuration of a liquid crystal display panel according to a third embodiment of the present invention. FIG. 11 is a plan view illustrating an example of a configuration of one pixel in the liquid crystal display panel according to the third embodiment. FIG. 12 is a cross-sectional view taken along the line E-E′ of FIG. 11, and illustrates inclination of liquid crystal molecules when a display is made in black. FIG. 13 is a cross-sectional view taken along the line F-F′ of FIG. 11, and illustrates liquid crystal molecules when a display is made in black.

In the first and second embodiments, descriptions were provided for a configuration when the present invention is applied to a transmission liquid crystal display panel based on the VA system. However, the present invention is not limited to the transmission liquid crystal display panels, and can be applied to a semi-transmission liquid crystal display panel. Therefore, in the third embodiment, description is provided for an example of a configuration of a semi-transmission liquid crystal display panel based on the VA system.

On the TFT substrate 1 of the liquid crystal display panel according to the third embodiment, as shown in FIG. 11 to FIG. 13, a semiconductor layer 104, a scan signal line 106, a video signal line 108A, a source electrode 108B, a first pixel electrode 111A and the like are provided on a glass substrate. In this configuration, each pixel area has a transmission display area which is transmissible to light from a back light and display images and a reflection display area which reflects from light from the outside and displays images, and a step-forming layer 115 is provided on the reflective area. A second pixel electrode 111B is provided on the step-forming layer 115. In the liquid crystal display panel according to the third embodiment, the second pixel electrode 111B also functions as a reflection film which reflects light from the outside, and is formed by laminating, for instance, an AI film and a MoW film.

The liquid crystal display panel according to the third embodiment is semi-transmissible, and in the transmission display area, light comes into the liquid crystal layer 3 from the TFT substrate 1 and goes out from the counter substrate 2. On the other hand, in the reflection display area, the light coming into the liquid crystal layer 3 from the counter substrate 2 is reflected by the TFT substrate 1, passes through the liquid crystal layer 3, and goes out from the counter substrate 2. Because of the configuration, in the semi-transmission liquid crystal display panel, the step-forming layer 115 and the second pixel electrode 111B are formed in the reflection display area, so that a thickness of the liquid crystal layer in the reflection display area is smaller than that of the liquid crystal layer in the transmission display area. In this configuration, the thickness of the liquid crystal layer is desirably around a half of a thickness of the liquid crystal layer in the transmission display area. With the configuration as described above, for instance, when retardation of the liquid crystal layer in the reflection display area when a display is made in white is 200 nm, retardation of the liquid crystal layer in the light-transmissible area is about 400 nm, so that the voltage-reflectance characteristics is substantially identical to the voltage-transmittance characteristics. Because of the feature, it is possible to realize reflection display and transmission display not giving any sense of discomfort within a range of the drive voltage.

Furthermore, in this configuration, a portion of an end face of the second pixel electrode 111B along an end portion of the step-forming layer 115 protrudes toward the transmission display area, and is electrically connected to the first pixel electrode 111A. In other words, in the liquid crystal display panel according to the third embodiment, there is an area in which any pixel electrode is not present around an end portion of the step-forming layer 115 within one pixel area surrounded by adjacent two scan signal lines 106 and adjacent two video signal lines 108A.

Furthermore, in the liquid crystal display panel according to the third embodiment 3, the protrusion 113 for alignment control is provided in a section (slit) between first pixel electrodes 111A in two adjacent pixel areas.

Also in the liquid crystal display panel according to the third embodiment, the liquid crystal layer 3 is, for instance, a negative type of liquid crystal with a birefringence anisotropy Δn of 0.10, and in the case where a display is made in black when the voltage is OFF, namely when a difference in potential between the first pixel electrode 111A and the second pixel electrode 111B is 0 (zero), the liquid crystal molecules 301 are aligned in the vertical direction with respect to a surface of the substrate. It is to be noted that, in an area in which the protrusion 113 for alignment control is provided, when the voltage is OFF, the liquid crystal molecules 301 are aligned in the substantially vertical direction to an inclined face of the protrusion 113 for alignment control (alignment film 112). Furthermore, in the case of the semi-transmission liquid crystal display panel, as shown in FIG. 13, there is an inclined face also at an end portion of the step-forming layer 115, and also in this area, when the voltage is OFF, the liquid crystal molecules 301 are aligned in the substantially vertical direction with respect to the inclined face of the step-forming layer 115 (alignment film 112).

Also in the case of the liquid crystal display panel according to the third embodiment, when the voltage is OFF, namely when a difference in potential between the first pixel electrode 111A and the second pixel electrode 111B is 0 (zero), an electric potential different from that of the first pixel electrode 111A and the second pixel electrode 111B and different from that of the counter electrode 204 when a display is made in black is generated in the common electrode 114 of the TFT substrate 1. In this state, a relation in electric potential between the first pixel electrode 111A or the second pixel electrode 111B and the counter electrode 204 is as described in the first embodiment. With the configuration as described above, when a display is made in black, for instance, as shown in FIG. 12, a fringe electric field E_{F} is generated between the adjacent first pixel electrodes 111A, and a diagonal electric field is applied to the liquid crystal layer 3 around the protrusion 113 for alignment control. Therefore, inclination of the liquid crystal molecules 301 which is aligned in the substantially vertical direction to an outer peripheral portion (inclined face) of the protrusion 113 for alignment control when the common electrode 114 is not present is changed to a direction vertical to a surface of the substrate (a surface of the pixel electrode 111) because of the presence of the common electrode 114. As a result, leakage of light in a domain where the protrusion 113 for alignment control is arranged can be reduced when a display is made in black with the transmission contrast improved.

In the liquid crystal display panel according to the third embodiment, when a display is made in black, as shown in FIG. 13, a fringe electric field E_{F} is generated also in a domain at an end portion (inclined face) of the step-forming layer 115 in which the pixel electrodes 111A, 111B are not present, and a diagonal electric field is applied to the liquid crystal layer 3 around the inclined face of the step-forming layer 115. Therefore, inclination of liquid crystal molecules which is orientated in the substantially vertical direction to the inclined face of the step-forming layer 115 when there is not the common electrode 114 is changed to the direction vertical to a surface of the substrate (a surface of the pixel electrode 111). As a result, light leakage which occurs on the inclined face of the step-forming layer 115 when a display is made in black, namely at a border between the transmission display area and the reflection display area can be reduced with the transmission contrast improved.

Furthermore, by providing the protrusion 113 for alignment control, fluctuation of a domain center dependent on strength of an electric field corresponding to a difference in potential between the first pixel electrode 111A and the counter electrode 204 can be suppressed. Because of the feature, non-uniformity in brightness caused by movement of the domain center can be suppressed.

Also in the liquid crystal display panel according to the third embodiment of the present invention, a holding capacitance can be formed between the first pixel electrode 111A and the common electrode 114. In this case, when an transparent electrode is employed as the common electrode 114, a holding capacitance can be formed in a display area of each pixel, namely in a light-transmissible area of each pixel. Because of the feature, a freedom degree in designing the TFT substrate 1 increases, which facilitates designing of a precise and fine panel.

A method of manufacturing the liquid crystal display panel according to the third embodiment is briefly described below.

When the TFT substrate 1 of the liquid crystal display panel according to the third embodiment is manufactured, the manufacturing procedure described in the first embodiment can be employed up to the step of forming the first pixel electrode 111A, and detailed description thereof is not provided herein.

After formation up to the first pixel electrode 111A is finished, the protrusion 113 for alignment control and the step-forming layer 115 are formed. The protrusion 113 for alignment control is formed according to the procedure described in the first embodiment 1. Furthermore, also the step-forming layer 115 is formed according to the same procedure as that for forming the protrusion 113 for alignment control. The protrusion 113 for alignment control is formed so that the thickness after sintering is about 1.0 μm, while the step-forming layer is formed so that the thickness after sintering is about 2.0 μm.

Then, the second pixel electrode 111B is formed on the step-forming layer 115. The second pixel electrode 111B is formed, for instance, by subjecting an AI film and a MoW film prepared by sputtering to patterning. When the laminated films is subjected to patterning, at first, for instance, a photo-resistive resist is formed, and then the photo-sensitive resist is exposed to light using a photo mask with a desired pattern drawn thereon, and then the photo-sensitive resist is partially removed with an alkaline developer to form an etching resist. Then the laminated films are partially removed by using a phosphoric acid etching solution, and the etching resist is removed. Furthermore, a portion of the second pixel electrode 111B protrudes, as shown, for instance, in FIG. 11, toward the first pixel electrode 111A to form a pattern passing through a portion of an end section (inclined face) of the step-forming layer 115 and overlapping the first pixel electrode 111A.

After the second pixel electrode 111B is formed, the alignment film 112 is formed by the method described in the first embodiment. With the processing sequence described above, the TFT substrate 1 is formed for the liquid crystal display panel according to the third embodiment.

The counter substrate 2 may be manufactured according to the same procedure as that for manufacturing a counter electrode in the conventional technology, and detailed description thereof is omitted.

When a liquid crystal display panel is manufactured using the TFT substrate 1 and the counter substrate 2 prepared as described above, at first the liquid crystal material 2 is vacuum-sealed between the TFT substrate 1 and the counter substrate 2. When the liquid crystal material 3 is vacuum-sealed, for instance, a gap (cell gap) between the TFT substrate and the counter substrate 2 is set to 4.0 μm, for instance, with a sealing material 4 and a spacer (SOC), and a negative liquid crystal with a birefringence anisotropy Δn of 0.10 is vacuum-sealed in the gap. In this state, the liquid crystal molecules 301 are orientated in a direction vertical to a surface of the substrate due to an alignment restricting force provided by the alignment film 112, 204 based on the VA system. In the area in which the protrusion 113 for alignment control is provided, the liquid crystal molecules 301 is aligned in a direction substantially vertical not to the substrate surface, but to the inclined face of the protrusion 113 for alignment control (alignment film 112). At an end portion of the step-forming layer 115, the liquid crystal molecules 301 are aligned in a direction substantially vertical not to the substrate surface, but to the inclined face of the step-forming layer 115 (alignment film 112).

Then the upper wave plate 5B and the upper deflecting plate 6B are adhered to each other, and the lower deflecting plate 5A and the lower deflecting plate 6A are adhered to each other. In this process, the upper circular deflecting plate includes the upper deflecting plate 6B and the upper wave plate 5B, and the lower circular deflecting plate includes the lower deflecting plate 6A and the lower wave plate 5A. The upper and lower circular deflecting plates sandwich the liquid crystal layer, and the angle of the upper deflecting plate and the angle of the lower circular deflecting plate are different by 90 degrees from each other.

When the semi-transmission liquid crystal display unit is manufactured by using the liquid crystal display panel according to the third embodiment, the same procedure as that employed for manufacturing the conventional type of semi-conductor liquid crystal display unit may be employed, and detailed description thereof is omitted.

As described above, in the liquid crystal display panel according to the third embodiment, when a display is made in black, light leakage, which occurs between the adjacent first pixel electrodes 111A (slit) and at an end portion of the step-forming layer 115, can be reduced, so that the transmittance when a display is made in black can be reduced. As a result, the transmission contrast (transmittance when a display is made in white/transmittance when a display is made in black) can be made higher.

Furthermore, by providing the protrusion 113 for alignment control, fluctuation of a domain center dependent on strength of an electric field corresponding to a difference in potential between the first pixel 111A and the counter electrode 204 can be suppressed. Because of the feature, non-uniformity in brightness due to movement of the domain center can be reduced.

In the liquid crystal display panel according to the third embodiment, a holding capacitance can be formed between the first pixel electrode 111A and the common electrode 114. In this configuration, when a transparent electrode is employed as the common electrode 114, a holding capacitance can be formed in a display area, namely a light-transmissible area of each pixel. Because of this, a freedom degree in deigning the TFT substrate 1 increases, which facilitates designing of a precise and fine panel.

The configuration of one pixel in the TFT substrate 1 as shown in FIG. 11 to FIG. 13 is an example of the semi-transmission type, but the present invention is not limited to this configuration, and other configurations are allowable in the present invention.

In the third embodiment, the protrusion 113 for alignment control is provided between adjacent first pixel electrodes 111A, but the present invention is not limited to this configuration, and, for instance, a configuration in which a circular or polygonal opening is provided around a center of each first pixel electrode 111A and the protrusion 113 for alignment control covering the opening is arranged.

The present invention are described above in detail with reference to the specific embodiments above, but the present invention is not limited to the embodiments, and it is needless to say that various modifications are allowable within the gist of the present invention.

Although the liquid crystal display panel based on the VA system is employed in each of the embodiments described above, the present invention is not limited to the configuration, and a liquid crystal display panel based on the TN system or the ECB system may be employed in the present invention.

What is claimed is:

1. A liquid crystal display device having a liquid crystal display panel in which a liquid crystal material is held between a first substrate and a second substrate,
wherein, in the liquid crystal display panel, liquid crystal molecules in the liquid crystal material are aligned in a direction vertical to a surface of the substrate when a display is made in black;
the second substrate has a first counter electrode;
the first substrate has a pixel electrode, a protrusion for alignment control, and a second counter electrode, the protrusion for alignment control being formed by partially protruding a surface of the first substrate facing against the second substrate, a second counter electrode being formed in a contrary side from the first counter electrode when viewed from the pixel electrode and having an electric potential different from an electric potential in the pixel electrode and from an electric potential in the first counter electrode when a display is made in black; and
the pixel electrode has a slit or an opening at a position where the protrusion for alignment control is formed, and the second counter electrode extends at a position overlapping the slit or the opening of the pixel electrode.

2. The liquid crystal display device according to claim 1,
wherein, the second counter electrode has an electric potential enabling an electric line of force generated between the second counter electrode and the pixel electrode when a display is made in black to pass through the slit or the opening of the pixel electrode

3. The liquid crystal display device according to claim 1,
wherein the second electrode is a transparent electrode.

4. The liquid crystal display device according to claim 1,
wherein, in the first substrate, a holding capacitance is formed between the pixel electrode and the second counter electrode.

5. A liquid crystal display device having a liquid crystal display panel in which a liquid crystal material is held between a first substrate and a second substrate,
wherein, in the liquid crystal display panel, liquid crystal molecules in the liquid crystal material are aligned in a direction vertical to a surface of the substrate when a display is made in black;
the second substrate has a first counter electrode;
the first substrate has, in one pixel area, first and second pixel electrodes, a step forming layer, and a second counter electrode, the first and second pixel electrodes having a different distance from the first counter electrode from each other, the step forming layer being formed in a domain overlapping either one of the first pixel electrode or the second electrode, the one nearer to the first counter electrode, and the second counter electrode being formed in a contrary side from the first counter electrode when viewed from the first pixel electrode and the second pixel electrode and having an electric potential different from an electric potential of the first pixel electrode and the second pixel electrode and different from an electric potential of the first counter electrode when a display is made in black;
the first substrate has a domain overlapping neither the first pixel electrode nor the second pixel electrode at an end portion of the step forming layer in the one pixel area; and
the second counter electrode extends through the domain overlapping neither the first pixel electrode nor the second pixel electrode at the end portion, and the second counter electrode extends at a domain in which the first pixel electrode is formed and at a domain in which the second pixel electrode is formed.

6. The liquid crystal display device according to claim 5,
wherein the second counter electrode has an electric potential enabling an electric line of force generated between the second counter electrode and the first pixel electrode or the second pixel electrode when a display is made in black to pass through the domain overlapping neither the first pixel electrode nor the second pixel electrode at the end portion.

7. The liquid crystal display device according to claim 5,
wherein the second counter electrode is a transparent electrode.

8. The liquid crystal display device according to claim 5,
wherein, in the first substrate, a holding capacitance is formed between the first pixel electrode or the second pixel electrode and the second counter electrode.

9. The liquid crystal display device according to claim 5,
wherein the first substrate has a protrusion for alignment control, the protrusion for alignment control being formed by partially protruding a substrate of the first surface facing against the second substrate; and
the first or second pixel electrode has a slit or an opening at a position where the protrusion for alignment control is formed, and the second counter electrode extends at a position overlapping the slit or the opening of the first or second pixel electrode.
